(19) United States
(12) Patent Application Publication
(10) Pub. No.: US 2026/0180614 A1
(43) Pub. Date: Jun. 25, 2026

(54) RADIO FREQUENCY TRANSCEIVER AND DEVICE INCLUDING THE SAME

(71) Applicant: ELECTRONICS AND TELECOMMUNICATIONS RESEARCH INSTITUTE, Daejeon (KR)

(72) Inventor: Jongho YOO, Daejeon (KR)

(73) Assignee: ELECTRONICS AND TELECOMMUNICATIONS RESEARCH INSTITUTE, Daejeon (KR)

(21) Appl. No.: 19/293,901

(22) Filed: Aug. 7, 2025

(30) Foreign Application Priority Data
Dec. 19, 2024 (KR) 10-2024-0191483

(51) Int. Cl. H04B 1/405; H04B 1/04

(52) U.S. Cl. CPC H04B 1/405; H04B 1/0458; H04B 1/0483; H04B 2001/0408

(57) ABSTRACT

A radio frequency (RF) transceiver and a device including the same are provided. The RF transceiver includes a switched inductor positioned on a first transmission path between the antenna and a first amplifier and a first matching network positioned on a second transmission path between the antenna and a second amplifier, wherein the switched inductor may include a first inductor and a first switch connected in parallel with the first inductor.

### CROSS-REFERENCE TO RELATED APPLICATION

This application claims the benefit of Korean Patent Application No. 10-2024-0191483, filed on Dec. 19, 2024, in the Korean Intellectual Property Office, the entire disclosure of which is incorporated herein by reference for all purposes.

### BACKGROUND

### 1. Field of the Invention

One or more embodiments relate to a radio frequency (RF) transceiver and a device including the same.

### 2. Description of the Related Art

A radio frequency (RF) transceiver is widely used in a communication scenario in which transmission and reception signals are separated, such as time division duplexing. In such a communication scenario, an RF antenna switch that can distinguish between transmission and reception modes is required.

The above description has been possessed or acquired by the inventor(s) in the course of conceiving the present disclosure and is not necessarily an art publicly known before the present application is filed.

### SUMMARY

Embodiments provide technology of reducing an area of a chip including a radio frequency (RF) transceiver.

Embodiments provide technology of minimizing loss of signals transmitted and received by an RF transceiver.

Embodiments provide technology of improving output of a signal transmitted by an RF transceiver and a noise figure (NF) received by the RF transceiver.

However, the technical goals are not limited to the aforementioned goals, and other technical goals may be present.

According to an aspect, there is provided a radio frequency RF transceiver connected to an antenna, the RF transceiver including a switched inductor positioned on a first transmission path between the antenna and a first amplifier and a first matching network positioned on a second transmission path between the antenna and a second amplifier, wherein the switched inductor may include a first inductor and a first switch connected in parallel with the first inductor.

The first amplifier may be a power amplifier (PA), and the second amplifier may be a low noise amplifier (LNA).

The first transmission path may be a transmission path for transmitting a signal to the antenna, and the second transmission path may be a reception path for transmitting a signal received from the antenna.

The first matching network may include a switched capacitor and a second inductor connected in parallel with the switched capacitor, wherein the switched capacitor may include a second switch and a capacitor connected in series with the second switch.

The RF transceiver may further include a third switch having one end portion connected to a connection node between the first matching network and the second amplifier and the other end portion connected to ground.

On/off switching of each of the first switch, the second switch, and the third switch may be controlled by a controller.

The controller may be implemented within the RF transceiver.

The RF transceiver may further include a second matching network positioned between the switched inductor and the first amplifier.

According to another aspect, there is provided an electronic device including an antenna and an RF transceiver connected to the antenna, wherein the RF transceiver may include a switched inductor positioned on a first transmission path between the antenna and a first amplifier and a first matching network positioned on a second transmission path between the antenna and a second amplifier, wherein the switched inductor may include a first inductor and a first switch connected in parallel with the first inductor.

The first amplifier may be a PA, and the second amplifier is an LNA.

The first transmission path may be a transmission path for transmitting a signal to the antenna, and the second transmission path may be a reception path for transmitting a signal received from the antenna.

The first matching network may include a switched capacitor and a second inductor connected in parallel with the switched capacitor, wherein the switched capacitor may include a second switch and a capacitor connected in series with the second switch.

The electronic device may further include a third switch having one end portion connected to a connection node between the first matching network and the second amplifier and the other end portion connected to ground.

On/off switching of each of the first switch, the second switch, and the third switch may be controlled by a controller.

The controller may be implemented within the RF transceiver.

The electronic device may further include a second matching network positioned between the switched inductor and the first amplifier.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a schematic diagram illustrating a radio frequency (RF) transceiver according to an embodiment;

FIGS. 2 and 3 are diagrams illustrating a structure of an RF transceiver according to an embodiment;

FIGS. 4 and 5 are diagrams illustrating a transmission mode of an RF transceiver according to an embodiment; and

FIGS. 6 and 7 are diagrams illustrating a reception mode of an RF transceiver according to an embodiment.

### DETAILED DESCRIPTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the embodiments will be described in detail with reference to the accompanying drawings. When describing the embodiments with reference to the accompanying drawings, like reference numerals refer to like components and a repeated description related thereto will be omitted.

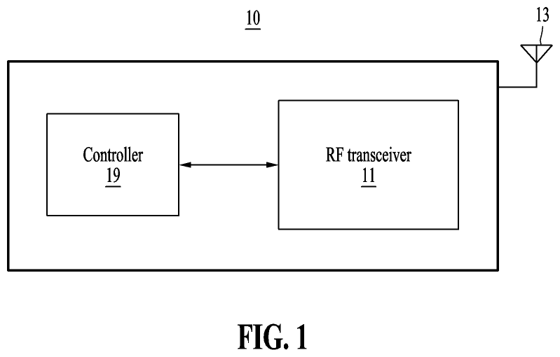

FIG. 1 is a schematic diagram illustrating a radio frequency (RF) transceiver according to an embodiment.

Referring to FIG. 1, according to an embodiment, an electronic device 10 may include an RF transceiver 11 and/or an antenna 13. The electronic device 10 may further include a controller 19 for controlling the RF transceiver 11. The electronic device 10 may be a wireless communication device. The RF transceiver 11 may include a processor (not shown) but is not limited thereto. The RF transceiver 11 may receive a digital signal from the processor (not shown) located outside the RF transceiver 11. The processor may modulate various pieces of digital data to generate digital signals. The processor may provide the generated digital signals to the RF transceiver 11. The processor may demodulate the digital signals received from the RF transceiver 11 and may restore the digital signals to original digital data. The RF transceiver 11 may convert the digital signal transmitted from the processor into an RF signal of an RF frequency band. The RF transceiver 11 may transmit the converted RF signal to the antenna 13. The RF transceiver 11 may convert the RF signal transmitted from the antenna 13 to a digital signal of a baseband.

According to an embodiment, the antenna 13 may receive (or obtain) the RF signal from the RF transceiver 11. The antenna 13 may transmit the RF signal received from the RF transceiver 11 to another electronic device (not shown). The antenna 13 may receive (or obtain) the RF signal from another electronic device (not shown). The antenna 13 may transmit (or deliver) the RF signal received from the electronic device (not shown) to the RF transceiver 11.

According to an embodiment, the controller 19 may change an operation mode (e.g., a transmission mode and a reception mode) of the RF transceiver 11. The controller 19 may generate a control signal for changing the operation mode of the RF transceiver 11. The controller 19 may change the operation mode of the RF transceiver 11 using the generated control signal.

According to an embodiment, the controller 19 may be mounted inside the RF transceiver 11. The controller 19 may be implemented within the RF transceiver 11. In the case of the controller 19 mounted inside the RF transceiver 11, the control signal for changing the operation mode of the RF transceiver 11 may be directly processed by the RF transceiver 11. The controller 19 may be located outside the RF transceiver 11. The controller 19 located outside the RF transceiver 11 may be connected to the RF transceiver 11 through wired or wireless communication.

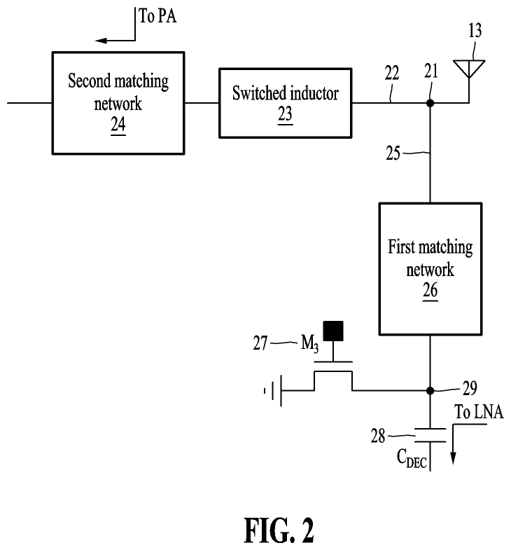

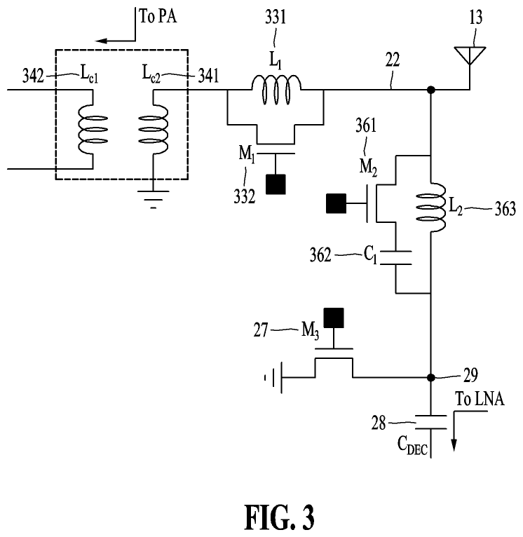

FIGS. 2 and 3 are diagrams illustrating a structure of an RF transceiver according to an embodiment.

Referring to FIG. 2, according to an embodiment, an RF transceiver (e.g., the RF transceiver 11) may include one or more transmission paths (e.g., a first transmission path 22 and a second transmission path 25). For example, the RF transceiver 11 may include the first transmission path 22 for connecting the antenna 13 to a first amplifier (not shown) and/or the second transmission path 25 for connecting the antenna 13 to a second amplifier (not shown). The first amplifier may be a power amplifier (PA). The first transmission path 22 may be a transmission path that transmits a signal from the first amplifier, which is the PA, to the antenna 13. The second amplifier may be a low noise amplifier (LNA). The second transmission path 25 may be a reception path that transmits a signal received from the antenna 13 to the second amplifier, which is the LNA.

According to an embodiment, one end portion of each of the first transmission path 22 and the second transmission path 25 may be connected to a node 21. The antenna 13 may be connected to the node 21 and may transmit or receive signals.

According to an embodiment, the RF transceiver 11 may include a switched inductor 23, a second matching network 24, and/or a first matching network 26. The first matching network 26 may be located on the second transmission path 25. The second matching network 24 and the switched inductor 23 may be located on the first transmission path 22. The second matching network 24 may be located between the switched inductor 23 and the first amplifier. One end portion of the second matching network 24 may be connected to the first amplifier but may not be directly connected thereto. The other end of the second matching network 24 may be connected to one end of the switched inductor 23. The other end of the switched inductor 23 may be connected to the node 21.

According to an embodiment, the second matching network 24 may provide matching impedance between the first amplifier and the antenna 13. The second matching network 24 may transform impedance of a transmission signal amplified from the first amplifier. For example, the second matching network 24 may match the impedance of the transmission signal amplified from the first amplifier to impedance of the antenna 13.

According to an embodiment, the first matching network 26 may be located between the node 21 and a connection node 29. One end portion of the first matching network 26 may be connected to the node 21, and the other end portion may be connected to the connection node 29. The first matching network 26 may provide matching impedance between the second amplifier and the antenna 13. The first matching network 26 may transform impedance of a reception signal received from the antenna 13. For example, the first matching network 26 may match the impedance of the reception signal received from the antenna 13 to the impedance of the second amplifier.

According to an embodiment, the RF transceiver 11 may further include a third switch 27. A first switch (e.g., a first switch 332 of FIG. 3) and a second switch (e.g., a second switch 361 of FIG. 3) are described in detail in FIG. 3. One end portion of the third switch 27 may be connected to the connection node 29, and the other end portion may be connected to ground. The third switch 27 may be turned on or off by a controller (e.g., the controller 19 of FIG. 1). For example, when a voltage higher than a threshold voltage is applied to a gate of the third switch 27, the third switch 27 may be turned on.

Referring to FIG. 3, according to an embodiment, a second matching network (e.g., the second matching network 24 of FIG. 2) may include one or more inductors (e.g., a first coupled inductor 342 and a second coupled inductor 341), but the second matching network 24 is not limited to this form. The second matching network 24 may include the first coupled inductor 342 and/or the second coupled inductor 341 in which one or more inductors are coupled. Both end portions of the first coupled inductor 342 may be connected to the first amplifier. One end portion of the second coupled inductor 341 may be connected to a switched inductor (e.g., the switched inductor 23 of FIG. 2). The other end portion of the second coupled inductor 341 may be connected to ground. Since the other end portion of the second coupled inductor 341 is connected to ground, the second coupled inductor 341 may provide a direct current path from the antenna 13 to the ground. Since the second coupled inductor 341 provides the direct current path from the antenna 13 to the ground, the first switch 332 may obtain resistance to electro static discharge (ESD).

According to an embodiment, the switched inductor (e.g., the switched inductor 23 of FIG. 2) may include a first inductor 331 and/or the first switch 332. The first switch 332 may be connected in parallel with the first inductor 331. The first switch 332 may be a transistor (e.g., a metal-oxide-semiconductor field-effect transistor (MOSFET) or an insulated gate bipolar transistor (IGBT)). The first switch 332 may be turned on or off by a controller (e.g., the controller 19 of FIG. 1). For example, when a voltage. higher than a threshold voltage is applied to a gate of the first switch 332, the first switch 332 may be turned on.

According to an embodiment, a first matching network (the first matching network 26 of FIG. 2) may include a switched capacitor and/or a second inductor 363. The second inductor 363 may be connected in parallel with the switched capacitor. The switched capacitor may include the second switch 361 and a capacitor 362. The capacitor 362 may be connected in series with the second switch 361. The second switch 361 may be turned on or off by the controller 19. For example, when a voltage higher than a threshold voltage is applied to a gate of the second switch 361, the second switch 361 may be turned on.

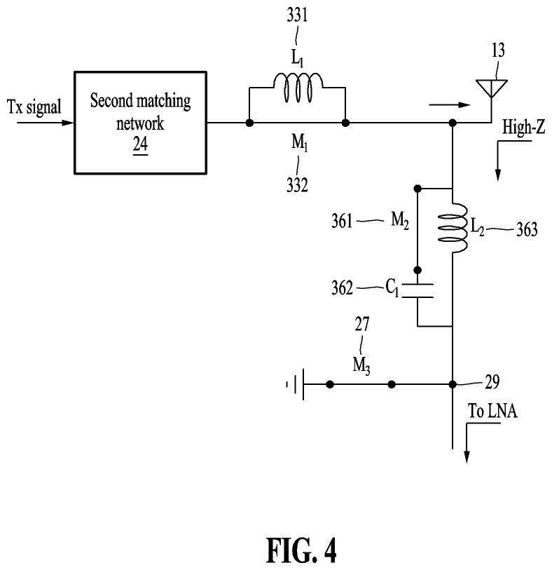

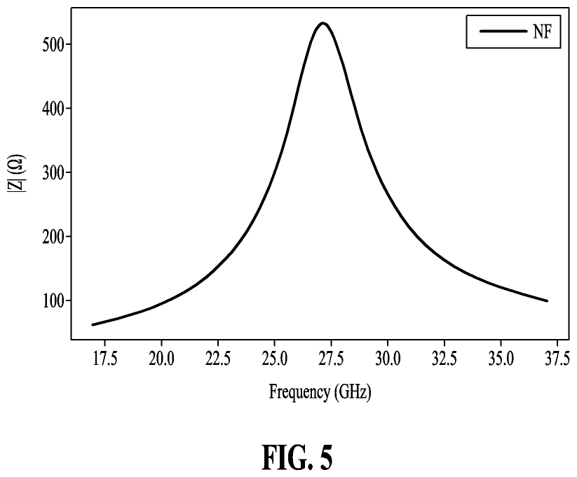

According to an embodiment, the controller 19 may respectively control on/off switching of the first switch 332, the second switch 361, and the third switch 27. The controller 19 may respectively control the first switch 332, the second switch 361, and the third switch 27 to be turned on. When each of the first switch 332, the second switch 361, and the third switch 27 is in a turned-on state, the controller 19 may cause an RF transceiver (e.g., the RF transceiver 11 of FIG. 1) to operate in a transmission mode. The transmission mode of the RF transceiver 11 is described in detail with reference to FIGS. 4 and 5.

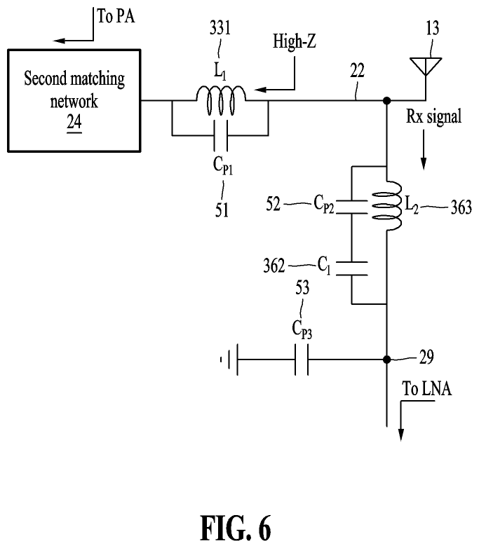

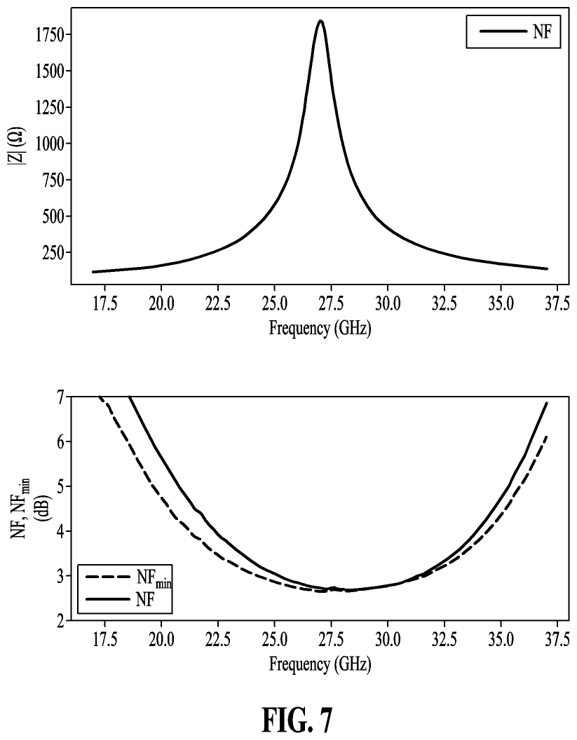

According to an embodiment, the controller 19 may respectively control the first switch 332, the second switch 361, and the third switch 27 to be turned off. When each of the first switch 332, the second switch 361, and the third switch 27 is in a turned-off state, the controller 19 may cause the RF transceiver 11 to operate in a reception mode. The reception mode of the RF transceiver 11 is described in detail with reference to FIGS. 6 and 7.

According to an embodiment, the RF transceiver 11 may reduce the physical size of the RF transceiver 11 by using the first inductor 331 and/or the second inductor 363 instead of a transmission line (e.g., a λ/4 transmission line). The RF transceiver 11 including the first inductor 331 connected in parallel with the first switch 332 and the second inductor 363 connected in parallel with the second switch 361 may be integrated into a smaller size than an RF transceiver including the λ/4 transmission line. When the RF transceiver 11 is integrated into a small size, the cost for manufacturing a chip including the RF transceiver 11 may be reduced.

FIGS. 4 and 5 are diagrams illustrating a transmission mode of an RF transceiver according to an embodiment.

Referring to FIG. 4, according to an embodiment, a controller (e.g., the controller 19 of FIG. 1) may apply a voltage higher than a threshold voltage to a gate of each of the first switch 332, the second switch 361, and the third switch 27. The controller 19 may respectively turn on the first switch 332, the second switch 361, and the third switch 27. When the first switch 332, the second switch 361, and the third switch 27 are turned on, each of the first switch 332, the second switch 361, and the third switch 27 may be expressed as a path through which a current may flow.

According to an embodiment, a transmission signal (Tx signal) introduced from a first amplifier, which is a PA, to a second matching network 24 may be transmitted to the antenna 13 through the first switch 332.

According to an embodiment, when the second switch 361 is turned on, a structure of a first matching network (e.g., the first matching network 26 of FIG. 2) may be changed so that the capacitor 362 is connected to the second inductor 363 in parallel. Impedance of the first matching network 26 in which the capacitor 362 is connected to the second inductor 363 in parallel may be obtained through Equation 1.

$$z = j ω {L}_{2} // \frac{1}{j ω {C}_{1}} = \frac{j ω {L}_{2}}{1 - {ω}^{2} {L}_{2} {C}_{1}} \qquad [ Equation 1 ]$$

Here, L₂ is inductance of the second inductor 363, and C₁ is capacitance of the capacitor 362.

According to an embodiment, an RF transceiver (e.g., the RF transceiver 11 of FIG. 1) may prevent the transmission signal from being introduced to the second transmission path 25 by adjusting the impedance of the first matching network 26. The RF transceiver 11 may increase the impedance of the first matching network 26 based on a resonant frequency w of the first matching network 26. For example, the resonant frequency w of the first matching network 26 may be obtained through Equation 2.

$$ω = \frac{1}{\sqrt{{L}_{2} {C}_{1}}} \qquad [ Equation 2 ]$$

According to an embodiment, the RF transceiver 11 may set the impedance of the first matching network 26 to be high in a range of the resonant frequency obtained through Equation 2. The RF transceiver 11 may set (or adjust) a value of capacitance (C₁) of the capacitor 362. The RF transceiver 11 may adjust the capacitance (C₁) value of the capacitor 362 to set the impedance of the first matching network 26 high. A user may adjust the capacitance (C₁) value of the capacitor 362 and may design the RF transceiver 11 to include the capacitor 362 in which the capacitance (C₁) value is adjusted.

According to an embodiment, when the third switch 27 is turned on, the third switch 27 may apply low impedance to a line between the connection node 29 and the ground connected to the other end of the third switch 27. The third switch 27 may apply low impedance to the line between the connection node 29 and the ground connected to the other end of the third switch 27 to prevent a large voltage from being applied to the second amplifier, which is an LNA. The third switch 27 may prevent the transmission signal introduced to the second transmission path 25 from being introduced to the second amplifier, which is the LNA. The transmission signal introduced to the second transmission path 25 may be a transmission signal introduced through the first matching network 26 in which the capacitor 362 is connected to the second inductor 363 in parallel.

Referring to FIG. 5, according to an embodiment, an RF transceiver (e.g., the RF transceiver 11 of FIG. 1) may determine impedance of the first matching network 26 based on the resonant frequency w of a first matching network (e.g., the first matching network 26 of FIG. 2) obtained from Equation 2. The RF transceiver 11 may cause the first matching network 26 to form a resonant state at a specific frequency. For example, when the resonant frequency w is about 27.5 gigahertz (GHz), the RF transceiver 11 may cause a circuit in which a capacitor (e.g., the capacitor 362 of FIG. 4) is connected to a second inductor (e.g., the second inductor 363 of FIG. 4) in parallel to form a resonant state.

According to an embodiment, the RF transceiver 11 may cause the first matching network 26 to form a resonant state based on the capacitance (C₁) value of the capacitor 362. The RF transceiver 11 may adjust the capacitance (C₁) value based on the capacitor 362, which is a variable capacitor.

According to an embodiment, the RF transceiver 11 may adjust the impedance of the first matching network 26 based on the capacitance (C₁) value of the capacitor 362. The RF transceiver 11 may adjust the impedance of the first matching network 26 based on the resonant frequency adjusted by the capacitance (C₁) value of the capacitor 362. For example, when the resonant frequency w is about 27.5 GHZ, the RF transceiver 11 may set the impedance of the first matching network 26 to about 500 ohms. In a frequency band of 27 GHz to 28 GHz, the RF transceiver 11 may set impedance seen towards the second amplifier, which is an LNA, to be greater than impedance of the antenna 13.

FIGS. 6 and 7 are diagrams illustrating a reception mode of an RF transceiver according to an embodiment.

Referring to FIG. 6, according to an embodiment, a controller (e.g., the controller 19 of FIG. 1) may or may not apply a voltage less than or equal to a threshold voltage to a gate of each of a first switch (e.g., the first switch 332 of FIG. 3), a second switch (e.g., the second switch 361 of FIG. 3), and a third switch (e.g., the third switch 27 of FIG. 3). The controller 19 may respectively turn off the first switch 332, the second switch 361, and the third switch 27. When the first switch 332, the second switch 361, and the third switch 27 are turned off, the first switch 332, the second switch 361, and the third switch 27 may each generate parasitic capacitance. For example, when the first switch 332 is turned off, parasitic capacitance (C_{P1}) 51 may occur at a position corresponding to a position of the first switch 332. When the second switch 361 is turned off, a parasitic capacitance (C_{P2}) 52 may occur at a position corresponding to a position of the second switch 361. When the third switch 27 is turned off, a parasitic capacitance (C_{P3}) 53 may occur at a position corresponding to a position of the third switch 27.

According to an embodiment, when the second switch 361 is turned off, the structure of a first matching network (e.g., the first matching network 26 of FIG. 2) may be changed so that the parasitic capacitance (C_{P2}) 52 is connected to the capacitor 362 in series and the second inductor 363, the parasitic capacitance (C_{P2}) 52, and the capacitor 362 are connected in parallel.

According to an embodiment, a reception signal (Rx signal) received from the antenna 13 may be transmitted to a second amplifier, which is an LNA, through the first matching network 26.

According to an embodiment, an RF transceiver (e.g., the RF transceiver 11 of FIG. 1) may prevent the reception signal from being introduced to the first transmission path 22 by adjusting impedance of a switched inductor (e.g., the switched inductor 23 of FIG. 2). For example, the RF transceiver 11 may adjust the impedance of the switched inductor 23 through Equation 3.

$$z = j ω {L}_{1} // \frac{1}{j ω {C}_{P 1}} = \frac{j ω {L}_{1}}{1 - {ω}^{2} {L}_{1} {C}_{P 1}} \qquad [ Equation 3 ]$$

Here, L₁ is inductance of the first inductor 331, and C_{P1} is the parasitic capacitance 51 of the first switch 332.

According to an embodiment, the RF transceiver 11 may adjust the impedance of the switched inductor 23 based on the resonant frequency w of the switched inductor 23, in Equation 3. The size of the first switch 332 may be fixed. When the size of the first switch 332 is fixed, the RF transceiver 11 may adjust the impedance of the switched inductor 23 based on the inductance of the first inductor 331. For example, the RF transceiver 11 may adjust the inductance value of the first inductor 331 to prevent the reception signal from being introduced to the first transmission path 22. A user may adjust the inductance value of the first inductor 331 and may design the RF transceiver 11 to include the inductor 331 in which the inductance value is adjusted.

According to an embodiment, the first matching network 26 may adjust impedance of the antenna 13 based on the parasitic capacitance (C_{P2}) 52, the capacitor 362, and the second inductor 363. For example, the first matching network 26 may match the impedance of the antenna 13 to impedance of the second amplifier, which is the LNA, based on the parasitic capacitance (C_{P2}) 52, the capacitor 362, and the second inductor 363.

Referring to FIG. 7, according to an embodiment, an RF transceiver (e.g., the RF transceiver 11 of FIG. 1) may determine impedance of the switched inductor 23 based on the resonant frequency w of a switched inductor (e.g., the switched inductor 23 of FIG. 2). The RF transceiver 11 may cause the switched inductor 23 to form a resonant state at a specific frequency. For example, when the resonant frequency w of the switched inductor 23 is about 27.5 GHZ, the RF transceiver 11 may cause a circuit in which a first inductor (e.g., the first inductor 331 of FIG. 6) is connected to a first switch (e.g., the first switch 332 of FIG. 3) in parallel to form a resonant state. Capacitance of the first switch 332 may be calculated as parasitic capacitance (e.g., the parasitic capacitance (C_{P1}) 51 of FIG. 6).

According to an embodiment, the RF transceiver 11 may adjust the impedance of the switched inductor 23 based on the inductance L₁ of the first inductor 331. The RF transceiver 11 may adjust the impedance of the switched inductor 23 based on a resonant frequency adjusted by the impedance L₁ value of the first inductor 331. For example, when the resonant frequency w is about 27.5 GHz, the RF transceiver 11 may set the impedance of the switched inductor 23 to about 1750 ohms. In a frequency band of 27 GHz to 28 GHz, the RF transceiver 11 may set impedance seen towards the first amplifier, which is a PA, to be greater than impedance of the antenna 13.

According to an embodiment, the graph below may be a result of simulating a noise figure (NF) of the RF transceiver 11. A minimum NF (NFₘᵢₙ) may represent an ideal NF of the RF transceiver, and the NF may represent an NF of the RF transceiver 11 shown in FIGS. 1 to 7. In a frequency band of 27 GHz to 28 GHz in which the impedance seen towards the first amplifier is set to be greater than the impedance of the antenna 13, the NF of the RF transceiver 11 may have a value converging to the minimum NF (NF_{min.}). The RF transceiver 11 may provide a matching impedance between an antenna (e.g., the antenna 13 of FIG. 2) and a first matching network (e.g., the first matching network 26 of FIG. 2) to improve the NF.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, a FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or combinations thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A radio frequency (RF) transceiver connected to an antenna, the RF transceiver comprising:
a switched inductor positioned on a first transmission path between the antenna and a first amplifier; and
a first matching network positioned on a second transmission path between the antenna and a second amplifier,
wherein the switched inductor comprises:
a first inductor; and
a first switch connected in parallel with the first inductor.

2. The RF transceiver of claim 1, wherein
the first amplifier is a power amplifier (PA), and
the second amplifier is a low noise amplifier (LNA).

3. The RF transceiver of claim 1, wherein
the first transmission path is a transmission path for transmitting a signal to the antenna, and
the second transmission path is a reception path for transmitting a signal received from the antenna.

4. The RF transceiver of claim 1, wherein
the first matching network comprises:
a switched capacitor; and
a second inductor connected in parallel with the switched capacitor,
wherein the switched capacitor comprises:
a second switch; and
a capacitor connected in series with the second switch.

5. The RF transceiver of claim 4, further comprising:
a third switch having one end portion connected to a connection node between the first matching network and the second amplifier and the other end portion connected to ground.

6. The RF transceiver of claim 5, wherein
on/off switching of each of the first switch, the second switch, and the third switch is controlled by a controller.

7. The RF transceiver of claim 6, wherein
the controller is implemented within the RF transceiver.

8. The RF transceiver of claim 1, further comprising:
a second matching network positioned between the switched inductor and the first amplifier.

9. An electronic device comprising:
an antenna; and
a radio frequency (RF) transceiver connected to the antenna,
wherein the RF transceiver comprises:
a switched inductor positioned on a first transmission path between the antenna and a first amplifier; and
a first matching network positioned on a second transmission path between the antenna and a second amplifier,
wherein the switched inductor comprises:
a first inductor; and
a first switch connected in parallel with the first inductor.

10. The electronic device of claim 9, wherein
the first amplifier is a power amplifier (PA), and
the second amplifier is a low noise amplifier (LNA).

11. The electronic device of claim 9, wherein
the first transmission path is a transmission path for transmitting a signal to the antenna, and
the second transmission path is a reception path for transmitting a signal received from the antenna.

12. The electronic device of claim 9, wherein
the first matching network comprises:
a switched capacitor; and
a second inductor connected in parallel with the switched capacitor,
wherein the switched capacitor comprises:
a second switch; and
a capacitor connected in series with the second switch.

13. The electronic device of claim 12, further comprising:
a third switch having one end portion connected to a connection node between the first matching network and the second amplifier and the other end portion connected to ground.

14. The electronic device of claim 13, wherein
on/off switching of each of the first switch, the second switch, and the third switch is controlled by a controller.

15. The electronic device of claim 14, wherein
the controller is implemented within the RF transceiver.

16. The electronic device of claim 9, further comprising:
a second matching network positioned between the switched inductor and the first amplifier.
